(19) United States
(12) Patent Application Publication
(10) Pub. No.: US 2009/0244099 A1
(43) Pub. Date: Oct. 1, 2009

(54) SWITCH METHODS AND SYSTEMS FOR INPUT INTERFACES

(76) Inventors: Jason VALALIK, Taoyuan (TW); Micah Shotel, Taoyuan (TW); Drew Bamford, Taoyuan (TW); Yu-Chuan Chen, Taoyuan (TW); Chung-Cheng Chen, Taoyuan (TW)

Correspondence Address: BIRCH STEWART KOLASCH & BIRCH, PO BOX 747, FALLS CHURCH, VA, 22040-0747, US

(21) Appl. No.: 12/244,108

(22) Filed: Oct. 2, 2008

(30) Foreign Application Priority Data
Mar. 28, 2008 (TW) 97111265

(51) Int. Cl. G09G 5/00

(52) U.S. Cl. 345/659

(57) ABSTRACT

Switch methods and systems for input interfaces for use in an electronic device are provided. First, a direction of the electronic device is detected. Then, a first input interface is determined among a plurality of input interfaces according to the direction of the electronic device, and the first input interface is displayed in a display unit of the electronic device.

### CROSS REFERENCE TO RELATED APPLICATIONS

This Application claims priority of Taiwan Patent Application No. 97111265, filed on Mar. 28, 2008, the entirety of which is incorporated by reference herein.

### BACKGROUND OF THE INVENTION

1. Field of the Invention

The disclosure relates generally to switch methods and systems for input interfaces, and, more particularly to methods and systems that switch and display various input interfaces according to a direction or a browse mode of an electronic device.

2. Description of the Related Art

Recently, portable devices, such as handheld devices, have become more and more technically advanced and multifunctional. For example, a handheld device may have e-mail message capabilities, an advanced address book management system, a media playback system, and various other functions. Due to increased convenience and functions of the devices, these devices have become necessities of life.

Handheld devices are usually equipped with input devices, such as a full-QWERTY keypad 100 as shown in FIG. 1, or a compact-QWERTY keypad 200 as shown in FIG. 2. Users can input data via the input devices provided by the handheld devices. For example, FIG. 3 shows a handheld device with a slide-out full-QWERTY keypad. The handheld device 300 can slide out the full-QWERTY keypad 100 for inputting data. Since the input device is a physical structure, it becomes a part of the developmental costs of the handheld device. In some handheld devices, the physical input devices can be replaced by virtual input interfaces. For these handheld devices, users can input data via the virtual input interface displayed on a touch-sensitive screen.

Additionally, since the height and width of handheld device screens are different, various browse modes, such as a portrait mode and a landscape mode are provided in the handheld device for various display effects. As previously described, users can input data via the virtual input interface displayed in the handheld device. Generally, the virtual input interface displayed by the handheld device is the same no matter what browse mode is used. For example, when the browse mode of the handheld device is the landscape mode, the handheld device displays a virtual input interface corresponding to the full-QWERTY keypad in the touch-sensitive screen. When the browse mode of the handheld device is the portrait mode, the handheld device also displays the virtual input interface corresponding to the full-QWERTY keypad in the touch-sensitive screen.

Since the full-QWERTY keypad belongs to a horizontal input interface, and has more input keys, it is suitable for use in the landscape mode. When the virtual input interface corresponding to the full-QWERTY keypad is displayed in the portrait mode, the virtual input interface cannot be completely displayed in the screen, and also becomes distorted.

### BRIEF SUMMARY OF THE INVENTION

Switch methods and systems for input interfaces are provided.

In an embodiment of a switch method for input interfaces for use in an electronic device, a direction of the electronic device is detected. Then, a first input interface is determined among a plurality of input interfaces according to the direction of the electronic device. The first input interface is displayed in a display unit of the electronic device.

In an embodiment of a switch method for input interfaces for use in an electronic device, a first input interface is determined among a plurality of input interfaces according to a browse mode of the electronic device. Then, the first input interface is displayed in a display unit of the electronic device.

An embodiment of a switch system for input interfaces comprises a storage unit comprising a plurality of input interfaces, a display unit, and a processing unit. The processing unit determines a first input interface among the input interfaces according to a browse mode of an electronic device, and displays the first input interface in the display unit.

An embodiment of a switch system for input interfaces comprises a storage unit comprising a plurality of input interfaces, a motion sensor, a display unit, and a processing unit. The motion sensor detects a direction of an electronic device. The processing unit determines a first input interface among the input interfaces according to the direction of the electronic device, and displays the first input interface in the display unit.

Switch methods and systems for input interfaces may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating a full-QWERTY keypad;

FIG. 2 is a schematic diagram illustrating a compact-QWERTY keypad;

FIG. 3 is a schematic diagram illustrating a handheld device with a slide-out full-QWERTY keypad;

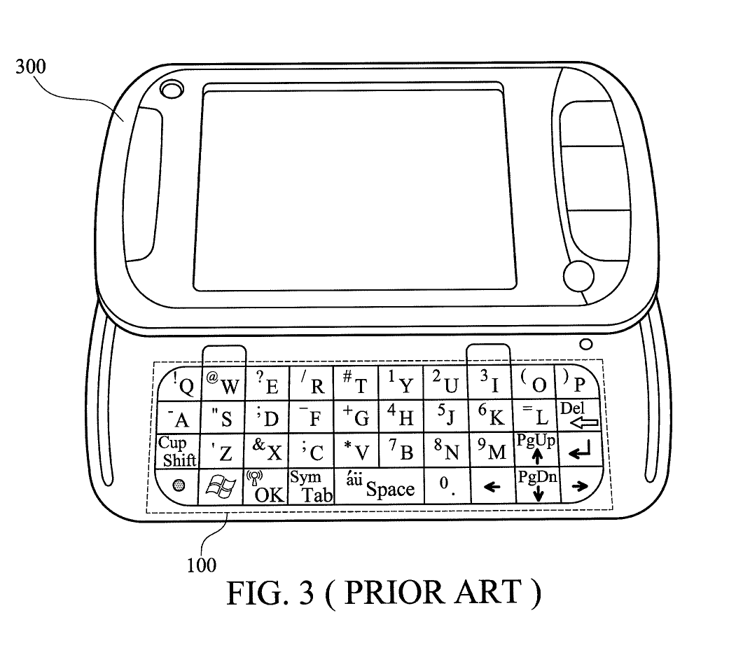

FIG. 4 is a schematic diagram illustrating an embodiment of a switch system for input interfaces of the invention;

FIG. 5 is a flowchart of an embodiment of a switch method for input interfaces of the invention;

FIG. 6 is a schematic diagram illustrating an embodiment of a picture in the landscape mode of the invention;

FIG. 7 is a schematic diagram illustrating an embodiment of a picture in the portrait mode of the invention;

FIG. 8 is a flowchart of an embodiment of a switch method for input interfaces of the invention; and

FIG. 9 is a flowchart of an embodiment of a switch method for input interfaces of the invention.

### DETAILED DESCRIPTION OF THE INVENTION

Switch methods and systems for input interfaces are provided.

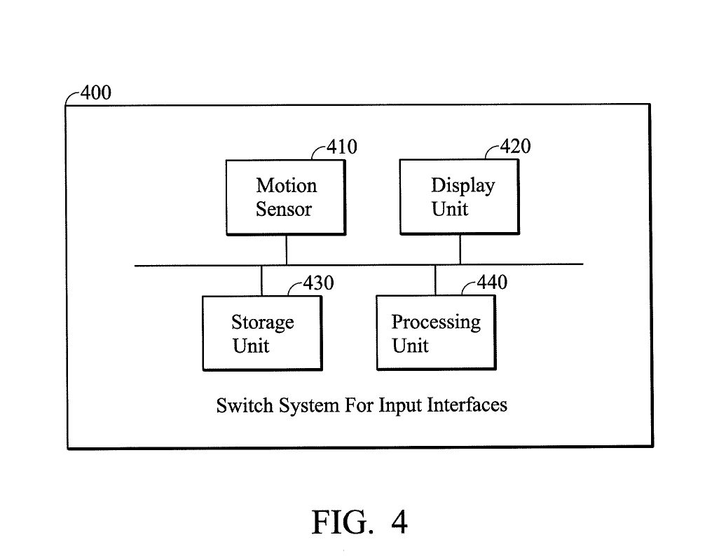

FIG. 4 is a schematic diagram illustrating an embodiment of a switch system for input interfaces of the invention. The switch system for input interfaces can be used in an electronic device, such as a portable device comprising handheld devices such as a media player, a PDA (Personal Digital Assistant), a GPS (Global Positioning System) device, a touch-sensitive phone, a smart phone, and a mobile phone.

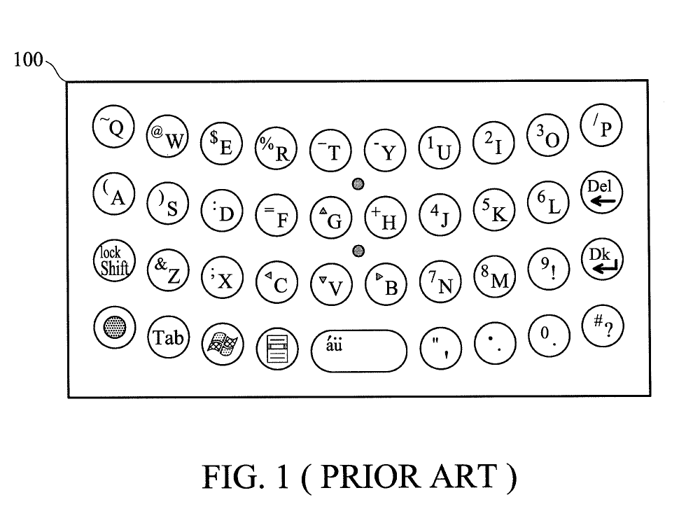

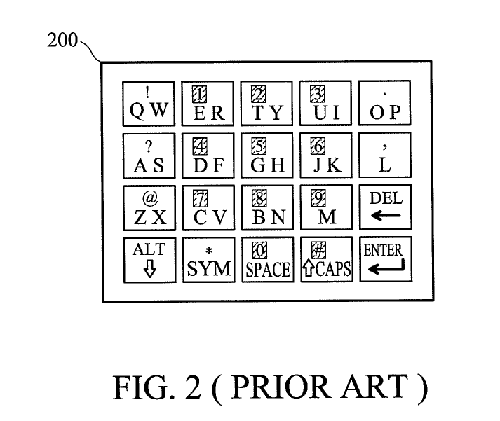

The switch system for input interfaces 400 comprises a motion sensor 110, a display unit 120, a storage unit 130, and a processing unit 140. The motion sensor 110 detects a direction of the electronic device. The display unit 120 can be a touch-sensitive screen to display data and receive related inputs. The storage unit 130 comprises a plurality of input interfaces respectively corresponding to various physical keypads. For example, the storage unit 130 stores a virtual input interface corresponding to the full-QWERTY keypad in FIG. 1, and a virtual input interface corresponding to the compact-QWERTY keypad in FIG. 2. It is understood that, the number of keys in the compact-QWERTY keypad is less than that in the full-QWERTY keypad. In some embodiments, the compact-QWERTY keypad includes 20 keys. Additionally, the storage unit 130 further comprises data provided to be browsed by the electronic device. The processing unit 140 performs the switch method for input interfaces of the application, which will be discussed further in the following paragraphs.

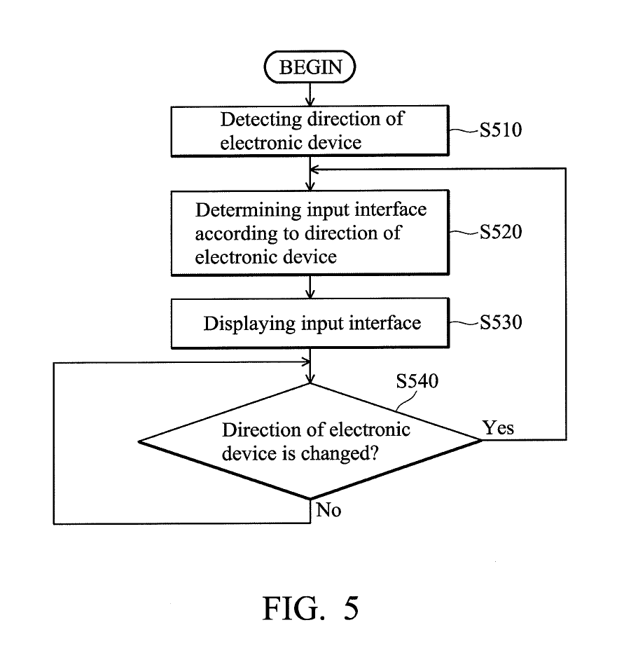

FIG. 5 is a flowchart of an embodiment of a switch method for input interfaces of the invention. The switch method for input interfaces is used for an electronic device, such as a portable device comprising handheld devices such as a media player, a PDA, a GPS device, a touch-sensitive phone, a smart phone, and a mobile phone. In some embodiments, the electronic device can perform webpage browsing, thus to obtain data from the Internet for browsing, and input data via an input interface displayed in the display unit.

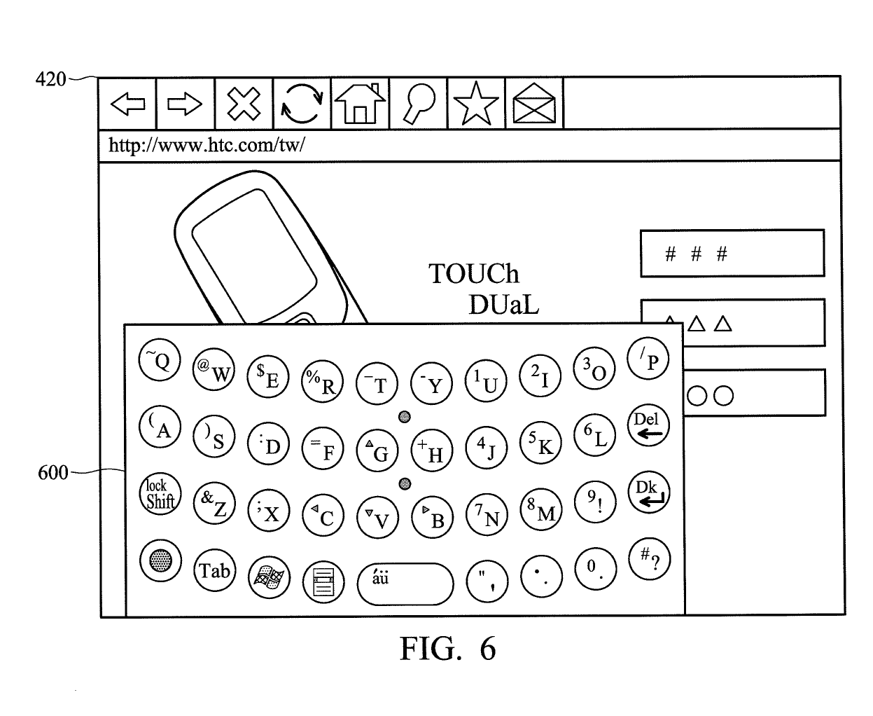

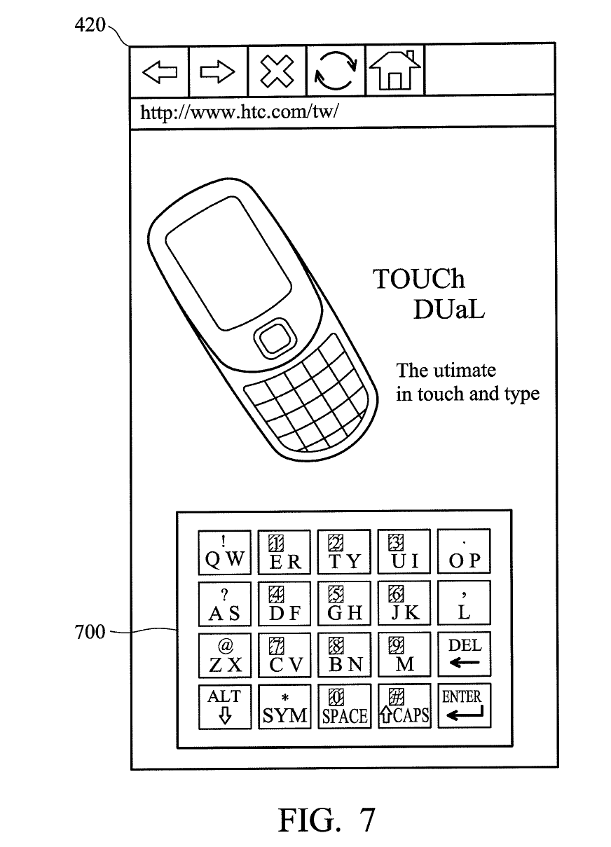

In step S510, the motion sensor detects a direction of the electronic device. In step S520, a first input interface is determined among the input interfaces in the storage unit according to the direction of the electronic device, and in step S530, the first input interface is displayed in the display unit of the electronic device. It is noted that, the motion sensor continually detects the direction of the electronic device. Then, in step S540, it is determined whether the direction of the electronic device is changed. If the direction of the electronic device is not changed (No in step S540), the procedure remains at step S540. If the direction of the electronic device is changed (Yes step S540), the procedure returns to step S520, a second interface is determined among the input interfaces in the storage unit according to the changed direction, and in step S530, the second input interface is displayed in the display unit of the electronic device. It is understood that, in some embodiments, when the direction of the electronic device is horizontal, the first input interface 600 displayed in the display unit can be a full-QWERTY keypad, and has the input functions corresponding to the full-QWERTY keypad, as shown in FIG. 6. When the direction of the electronic device is vertical, the second input interface 700 displayed in the display unit can be a compact-QWERTY keypad, and has the input functions corresponding to the compact-QWERTY keypad, as shown in FIG. 7. As described, the number of keys in the compact-QWERTY keypad is less than that in the full-QWERTY keypad. In some embodiments, the compact-QWERTY keypad includes 20 keys.

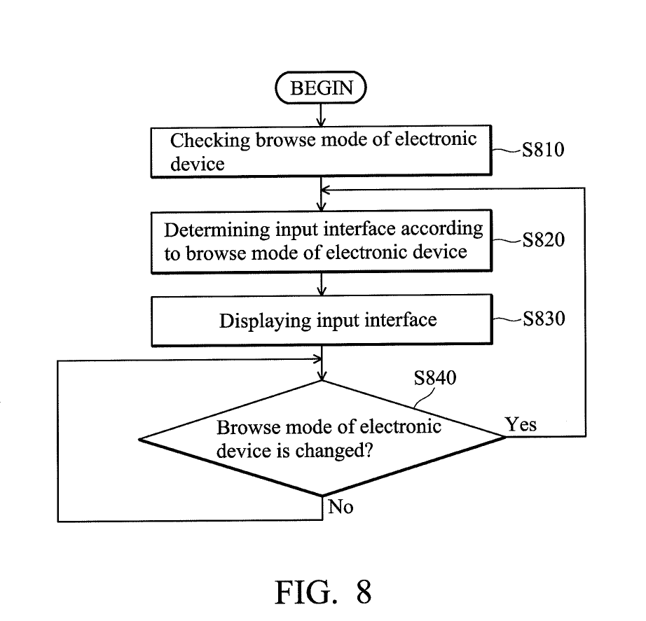

FIG. 8 is a flowchart of an embodiment of a switch method for input interfaces of the invention. The switch method for input interfaces is used for an electronic device, such as a portable device comprising handheld devices such as a media player, a PDA, a GPS device, a touch-sensitive phone, a smart phone, and a mobile phone. In some embodiments, the electronic device can provide several browse modes, such as a portrait mode, and a landscape mode to browse data. In some embodiments, the electronic device can perform webpage browsing, thus to obtain data from the Internet for browsing, and input data via an input interface displayed in the display unit.

In step S810, the current browse mode of the electronic device is checked. In step S820, a first input interface is determined among the input interfaces in the storage unit according to the current browse mode, and in step S830, the first input interface is displayed in the display unit of the electronic device. Then, in step S840, it is determined whether the browse mode of the electronic device is changed. If the browse mode of the electronic device is not changed (No in step S840), the procedure remains at step S840. If the browse mode of the electronic device is changed (Yes step S840), the procedure returns to step S820, a second interface is determined among the input interfaces in the storage unit according to the changed browse mode, and in step S830, the second input interface is displayed in the display unit of the electronic device. In some embodiments, when the browse mode is the landscape mode, the first input interface can be a full-QWERTY keypad, and has the input functions corresponding to the full-QWERTY keypad. When the browse mode is the portrait mode, the second input interface can be a compact-QWERTY keypad, and has the input functions corresponding to the compact-QWERTY keypad.

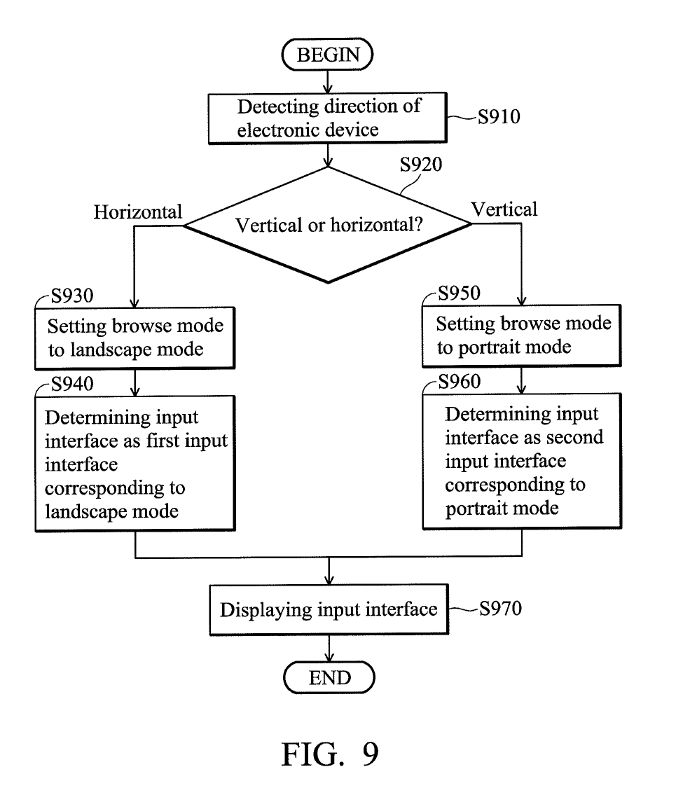

FIG. 9 is a flowchart of an embodiment of a switch method for input interfaces of the invention. The switch method for input interfaces is used for an electronic device, such as a portable device comprising handheld devices such as a media player, a PDA, a GPS device, a touch-sensitive phone, a smart phone, and a mobile phone. In some embodiments, the electronic device can provide several browse modes, such as a portrait mode, and a landscape mode to browse data, and the browse modes can be set according to the direction of the electronic device. In some embodiments, the electronic device can perform webpage browsing, thus to obtain data from the Internet for browsing, and input data via an input interface displayed in the display unit.

In step S910, the motion sensor detects a direction of the electronic device. In step S920, it is determined whether the direction of the electronic device is horizontal or vertical. When the direction of the electronic device is horizontal, in step S930, the browse mode of the electronic device is set to the landscape mode, and in step S940, a first input interface corresponding to the landscape mode is determined. Then, in step S970, the determined input interface is displayed. When the direction of the electronic device is vertical, in step S950, the browse mode of the electronic device is set to the portrait mode, and in step S960, a second input interface corresponding to the portrait mode is determined. Then, in step S970, the determined input interface is displayed. Users can input data via the input interface displayed in the display unit. It is understood that, the input interfaces corresponding to the portrait mode and the landscape mode can be defined in advance. Similarly, in some embodiments, when the browse mode is the landscape mode, the first input interface can be a full-QWERTY keypad, and has the input functions corresponding to the full-QWERTY keypad. When the browse mode is the portrait mode, the second input interface can be a compact-QWERTY keypad, and has the input functions corresponding to the compact-QWERTY keypad.

It is noted that, only two directions and two corresponding browse modes are discussed in the above embodiments. However, in some embodiments, the electronic device may provide several browse modes according to various requirements, and when the electronic device is at specific angle, at least one browse mode and a corresponding input interface are automatically set according to the specific angle.

Therefore, the switch methods and systems for input interfaces can switch and display various input interfaces according to the direction and/or the browse mode of the electronic device.

Switch methods and systems for input interfaces, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A switch method for input interfaces for use in an electronic device, comprising:
providing a plurality of input interfaces;
determining a first input interface among the input interfaces according to a browse mode of the electronic device; and
displaying the first input interface in a display unit of the electronic device.

2. The method of claim 1, further comprising:
determining whether the browse mode of the electronic device is changed;
when the browse mode of the electronic device is changed, determining a second input interface among the input interfaces according to the changed browse mode; and
displaying the second input interface in the display unit of the electronic device.

3. The method of claim 2, wherein when the browse mode is a landscape mode, the first input interface has input functions corresponding to a full-QWERTY keypad.

4. The method of claim 3, wherein when the changed browse mode is a portrait mode, the second input interface has input functions corresponding to a compact-QWERTY keypad, wherein the number of keys in the compact-QWERTY keypad is less than that in the full-QWERTY keypad.

5. The method of claim 1, further comprising:
detecting a direction of the electronic device; and
setting the browse mode according to the direction of the electronic device.

6. The method of claim 5, wherein when the direction of the electronic device is vertical, the browse mode is set to a portrait mode.

7. The method of claim 5, wherein when the direction of the electronic device is horizontal, the browse mode is set to a landscape mode.

8. The method of claim 1, further comprising:
obtaining data; and
browsing the data according to the browse mode.

9. A switch method for input interfaces for use in an electronic device, comprising:
providing a plurality of input interfaces;
detecting a direction of the electronic device;
determining a first input interface among the input interfaces according to the direction of the electronic device; and
displaying the first input interface in a display unit of the electronic device.

10. The method of claim 9, further comprising:
determining whether the direction of the electronic device is changed;
when the direction of the electronic device is changed, determining a second input interface among the input interfaces according to the changed direction; and
displaying the second input interface in a display unit of the electronic device.

11. The method of claim 10, wherein when the direction is horizontal, the first input interface has input functions corresponding to a full-QWERTY keypad.

12. The method of claim 11, wherein when the changed direction is vertical, and the second input interface has input functions corresponding to a compact-QWERTY keypad, wherein the number of keys in the compact-QWERTY keypad is less than that in the full-QWERTY keypad.

13. The method of claim 9, further comprising:
obtaining data from the Internet; and
performing webpage browsing to browse the data.

14. A switch system for input interfaces for use in an electronic device, comprising:
a storage unit comprising a plurality of input interfaces;
a display unit; and
a processing unit determining a first input interface among the input interfaces according to a browse mode of the electronic device, and displaying the first input interface in the display unit.

15. The system of claim 14, wherein the processing unit further determines whether the browse mode of the electronic device is changed, when the browse mode of the electronic device is changed, the processing unit determines a second input interface among the input interfaces according to the changed browse mode, and displays the second input interface in the display unit.

16. The system of claim 15, wherein when the browse mode is a landscape mode, the first input interface has input functions corresponding to a full-QWERTY keypad.

17. The system of claim 16, wherein when the changed browse mode is a portrait mode, the second input interface has input functions corresponding to a compact-QWERTY keypad, wherein the number of keys in the compact-QWERTY keypad is less than that in the full-QWERTY keypad.

18. The system of claim 14, further comprising a motion sensor detecting a direction of the electronic device, and the processing unit sets the browse mode according to the direction of the electronic device.

19. The system of claim 18, wherein when the direction of the electronic device is vertical, the processing unit sets the browse mode to a portrait mode.

20. The system of claim 18, wherein when the direction of the electronic device is horizontal, the processing unit sets the browse mode to a landscape mode.

21. The system of claim 14, wherein the processing unit further obtains data, and browses the data according to the browse mode.

22. A switch system for input interfaces for use in an electronic device, comprising:
a storage unit comprising a plurality of input interfaces;
a motion sensor detecting a direction of the electronic device;
a display unit; and
a processing unit determining a first input interface among the input interfaces according to the direction the electronic device, and displaying the first input interface in the display unit.

23. The system of claim 22, wherein the processing unit further determines whether the direction of the electronic device is changed, when the direction of the electronic device is changed, the processing unit determines a second input interface among the input interfaces according to the changed direction, and displays the second input interface in a display unit of the electronic device.

24. The system of claim 23, wherein when the direction is horizontal, the first input interface has input functions corresponding to a full-QWERTY keypad.

25. The system of claim 24, wherein when the changed direction is vertical, and the second input interface has input functions corresponding to a compact-QWERTY keypad, wherein the number of keys in the compact-QWERTY keypad is less than that in the full-QWERTY keypad.

26. The system of claim 22, wherein the processing unit further obtains data from the Internet, and performing webpage browsing to browse the data.

27. A machine-readable storage medium comprising a computer program, which, when executed, causes a device to perform a switch method for input interfaces, and the method comprising:
determining a first input interface among a plurality of input interfaces according to a browse mode of the device; and
displaying the first input interface.

28. A machine-readable storage medium comprising a computer program, which, when executed, causes a device to perform a switch method for input interfaces, and the method comprising:
detecting a direction of the device;
determining a first input interface among a plurality of input interfaces according to the direction of the device; and
displaying the first input interface.
